(19) United States
(12) Patent Application Publication
(10) Pub. No.: US 2023/0307737 A1
(43) Pub. Date: Sep. 28, 2023

(54) ACTIVE COOLING APPARATUS FOR BATTERY BACKUP UNITS

(71) Applicant: Baidu USA LLC, Sunnyvale, CA (US)

(72) Inventor: Tianyi GAO, San Jose, CA (US)

(21) Appl. No.: 17/700,695

(22) Filed: Mar. 22, 2022

(51) Int. Cl. H01M 10/613; H01M 10/6557; H01M 10/6568

(52) U.S. Cl. CPC H01M 10/613; H01M 10/6557; H01M 10/6568

(57) ABSTRACT

Embodiments are disclosed of a fluid injection apparatus. The fluid injection apparatus includes a supply manifold with a main inlet and a plurality of supply outlets. A manifold pump is fluidly coupled to the main inlet. One or more fluid injectors are adapted to be inserted among battery cells in a battery backup unit. Each fluid injector includes a hollow cylindrical tube having a first end, a second end, and a curved sidewall extending between the first end and the second end. The curved sidewall of each fluid injector includes a plurality of perforations, so that fluid can flow through the plurality of perforations from an interior channel of the fluid injector to an exterior of the fluid injector, and the first end of each fluid injector is fluidly coupled to a corresponding supply outlet.

### TECHNICAL FIELD

The disclosed embodiments relate generally to information technology (IT) cooling systems and in particular, but not exclusively, to an active cooling apparatus for battery backup units.

### BACKGROUND

Modern data centers like cloud computing centers house enormous amounts of information technology (IT) equipment such as servers, blade servers, routers, edge servers, power supply units (PSUs), battery backup units (BBUs), etc. These individual pieces of IT equipment are typically housed in racks within the computing center, with multiple pieces of IT equipment in each rack. The racks are typically grouped into clusters within the data center.

The main power source for IT equipment in each rack is generally a facility power source, such as electricity provided to the data center by an electrical utility. BBUs, as their name implies, are intended to provide backup power to IT equipment in a rack when the main power source fails or must be taken offline for maintenance. BBUs can also be used to provide power to other IT equipment in other scenarios, such as during peak power usage. When the BBU is providing power to the IT equipment in the rack, energy storage units in the BBU, e.g. batteries, are discharging. When they are not providing power to the IT equipment in the rack the batteries are either idle (i.e., neither charging nor discharging) or are being charged by the main power source. Charging and discharging the batteries generates heat, meaning that at times batteries in a BBU can require cooling. Battery heating becomes more problematic as the power consumption of IT equipment in the rack increases: higher energy consumption requires a higher battery discharge rate that generates more heat, and faster battery charging similarly generates more heat. Existing cooling solutions for battery packs rely in air cooling or liquid cooling, but these solutions might not enable high power density and high packaging densities. In addition, there is currently no mature design for backup battery packs with single-phase coolant for data center applications.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIGS. 1A-1C are views of an embodiment of a fluid delivery system for a battery backup unit. FIG. 1A is an exploded side view of the system, FIG. 1B a cross-sectional end view of a fluid injector, and FIG. 1C a cross-sectional side view along the axis of a fluid injector.

FIGS. 2A-2B are views of another embodiment of a fluid delivery system for a battery backup unit. FIG. 2A is an exploded side view of the system, FIG. 2B a cross-sectional side view along the axis of a fluid injector.

FIGS. 3A-3B are side views of embodiments of a battery backup unit including a fluid delivery system.

FIG. 4 is an end view of another embodiment of a fluid delivery system for battery backup units.

FIG. 5 is a side view of another embodiments of a battery backup unit including a fluid delivery system.

FIG. 6 is a side view of another embodiments of a battery backup unit including a fluid delivery system.

FIG. 7 is a side view of an embodiment of an IT enclosure including a battery backup unit with a fluid delivery system.

FIG. 8 is a side view of an embodiment of an IT enclosure including a battery backup unit with a fluid delivery system.

### DETAILED DESCRIPTION

Embodiments are described of an active cooling apparatus for battery backup units. Specific details are described to provide an understanding of the embodiments, but one skilled in the relevant art will recognize that the invention can be practiced without one or more of the described details or with other methods, components, materials, etc. In some instances, well-known structures, materials, or operations are not shown or described in detail but are nonetheless encompassed within the scope of the invention.

Reference throughout this specification to “one embodiment” or “an embodiment” means that a described feature, structure, or characteristic can be included in at least one described embodiment, so that appearances of “in one embodiment” or “in an embodiment” do not necessarily all refer to the same embodiment. Furthermore, the particular features, structures, or characteristics may be combined in any suitable manner in one or more embodiments. As used in this application, directional terms such as “front,” “rear,” “top,” “bottom,” “side,” “lateral,” “longitudinal,” etc., refer to the orientations of embodiments as they are presented in the drawings, but any directional term should not be interpreted to imply or require a particular orientation of the described embodiments when in actual use.

The present application discloses embodiments of a cooling solution for battery backup units that include clusters of battery cells. The described embodiments enable active liquid cooling for battery cells that have different thermal management requirements under different operation scenarios, and aim to provide more effective and optimized cooling for battery backup units in data centers. In addition, the disclosed embodiments enable some or all of the following benefits:

Thermal management of high power-density battery backup units.
High-efficiency fluid circulation management.
Accommodate different server and IT systems.
Improved battery cell performance, lifetime, and storage conditions.
Enable healthy conditions for cells.
Different cooling modes for backup battery systems.
Ease of implementation, service, and maintenance.
Modular design for different configurations.
Accommodate different use cases and deployment scales.

The disclosed embodiments enable highly efficient and effective liquid cooling for cells. The embodiments include fluid injection systems with multiple fluid injectors for distributing cooling fluid directly to battery cells during their charging and discharging cycles. The fluid injectors include one or more fluid connectors which engage and attach each fluid injector to a manifold or distribution panel. The distribution panel is assembled with a pump to take in fluid and distribute it to the fluid injectors. The fluid injectors are then inserted into openings among and between the battery cells, in either an axial or transverse direction. In an embodiment, both ends of the fluid injectors can be connected to distribution panels. The fluid injectors are actively operated to distribute cooling fluid to the battery cells. The fluid injection system is incorporated into a BBU, and both the BBU and its fluid injection system are submerged in the fluid.

In one aspect, a fluid injection apparatus includes a supply manifold including a main inlet and a plurality of supply outlets. A manifold pump is fluidly coupled to the main inlet and one or more fluid injectors are adapted to be inserted among battery cells in a battery backup unit. Each fluid injector comprises a hollow cylindrical tube having a first end, a second end, and a curved sidewall extending between the first end and the second end. The curved sidewall of each fluid injector includes a plurality of perforations, so that fluid can flow through the plurality of perforations from an interior channel of the fluid injector to an exterior of the fluid injector, and the first end of each fluid injector is fluidly coupled to a corresponding supply outlet.

In one embodiment each fluid injector is fluidly coupled by fluid connectors to the supply manifold. In another embodiment the second end of each fluid injector is open, so that fluid can flow through the second end from the interior channel of the fluid injector to the exterior of the fluid injector. One embodiment includes an additional supply manifold with a main inlet and a plurality of supply outlets, wherein each fluid injector has its second end coupled to a corresponding supply outlet of the additional supply manifold so that fluid flows from the additional supply manifold into the interior channel of the fluid injector, and another embodiment includes an additional manifold pump fluidly coupled to the main inlet of the additional supply manifold. In one embodiment the perforations are uniformly distributed over the area of the curved sidewall. And in another embodiment the one or more fluid injectors have a non-circular crosssectional shape.

In another aspect, a battery backup unit includes a battery housing having therein a plurality of perforations and a plurality of battery cells positioned in the battery housing. A fluid injection system is coupled to the housing and includes a supply manifold including a main inlet and a plurality of supply outlets and a manifold pump fluidly coupled to the main inlet. One or more fluid injectors are inserted among the plurality of battery cells. Each fluid injector comprises a hollow cylindrical tube having a first end, a second end, and a curved sidewall extending between the first end and the second end. The curved sidewall of each fluid injector includes a plurality of perforations, so that fluid can flow through the plurality of perforations from an interior channel of the fluid injector to an exterior of the fluid injector, and the first end of each fluid injector is fluidly coupled to a corresponding supply outlet.

In one embodiment the fluid injectors are positioned between groups of battery cells, each group including at least one battery cell. In one embodiment the fluid injectors are oriented parallel to the plurality of battery cells and in another embodiment the fluid injectors are oriented perpendicular to the plurality of battery cells. One embodiment includes an electrical bus electrically coupled to the plurality of battery cells. Another embodiment includes a charging/discharging controller electrically coupled to the electrical bus and a switch electrically coupled to the controller and to the manifold pump, wherein the charging/discharging controller activates the switch to direct electricity to the manifold pump when the plurality of battery cells is charging or discharging, and wherein, when the plurality of battery cells is charging, the manifold pump can be operated by electricity from the electrical bus. Yet another embodiment includes an additional supply manifold including a main inlet and a plurality of supply outlets, wherein each fluid injector has its second end coupled to a supply outlet of the additional supply manifold so that fluid flows from the additional supply manifold into the interior channel of the fluid injector.

In yet another aspect, an information technology (IT) enclosure includes an IT rack having a lower portion that forms a reservoir adapted to be filled with an immersion cooling fluid. One or more battery backup units are positioned in the IT rack. Each battery backup unit is submerged in the immersion cooling fluid, and includes a battery housing having a plurality of perforations and a plurality of battery cells positioned in the battery housing. A fluid injection system is coupled to the housing and includes a supply manifold including a main inlet and a plurality of supply outlets and a manifold pump fluidly coupled to the main inlet. One or more fluid injectors inserted among the plurality of battery cells and each fluid injector comprises a hollow cylindrical tube having a first end, a second end, and a curved sidewall extending between the first end and the second end. The curved sidewall of each fluid injector includes a plurality of perforations, so that fluid can flow through the plurality of perforations from an interior channel of the fluid injector to an exterior of the fluid injector, and the first end of each fluid injector is fluidly coupled to a corresponding supply outlet.

One embodiment includes a fluid distributor positioned in the IT rack and fluidly coupled to the manifold pump of each battery backup unit, and a rack supply pump fluidly coupled to the fluid distributor to pump immersion cooling fluid into the fluid distributor. Another embodiment includes a fluid distributor positioned in the IT rack and adapted to deliver immersion cooling fluid into the reservoir, and a rack supply pump fluidly coupled to the fluid distributor to pump immersion cooling fluid into the fluid distributor. In another embodiment, a rack outlet fluidly coupled to the reservoir and in yet another embodiment a rack outlet pump is fluidly coupled to the rack outlet to pump immersion cooling fluid out of the reservoir. Yet another embodiment includes an additional supply manifold with a main inlet and a plurality of supply outlets, wherein each fluid injector has its second end coupled to a corresponding supply outlet of the additional supply manifold so that fluid flows from the additional supply manifold into the interior channel of the fluid injector.

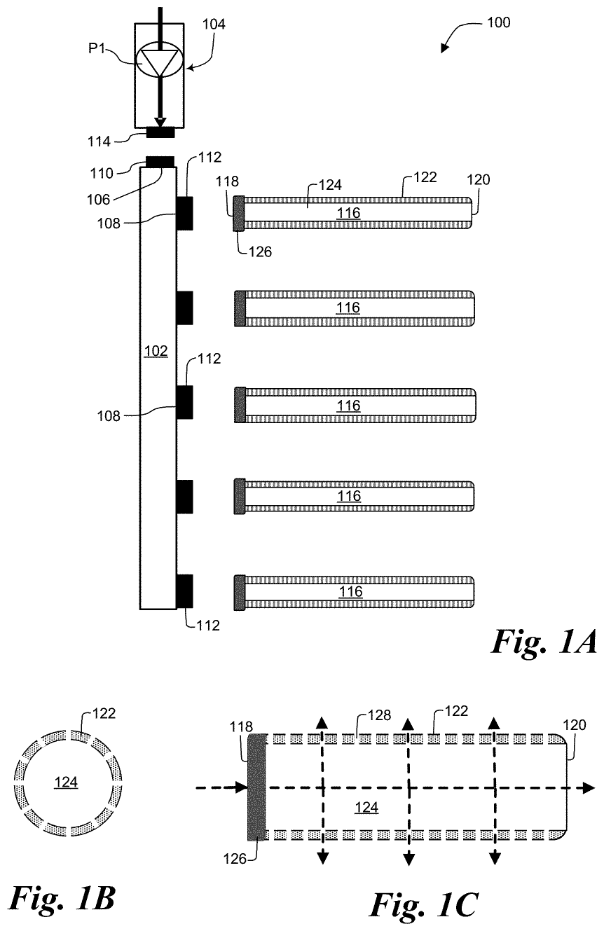

FIGS. 1A-1C together illustrate an embodiment of a fluid injection system 100. FIG. 1A is an exploded side view of the system, FIG. 1B is a cross-sectional end view of a fluid injector, and FIG. 1C is a cross-sectional side view of a fluid injector. Fluid injection system 100 includes a supply manifold 102 fluidly coupled to one or more fluid injectors 116. The illustrated embodiment has five fluid injectors 116 fluidly coupled to the manifold, but other embodiments can include more or less fluid injectors than shown. Supply manifold 102 includes a main inlet 106 and a plurality of supply outlets 108. Main inlet 106 includes a fluid connector 110, and each supply outlet 108 similarly includes a fluid connector 112. A pump module 104 includes a manifold pump P1 and has a fluid connector 114 that can engage with fluid connector 110, so that pump module 104 and manifold pump P1 can be fluidly coupled to manifold 102.

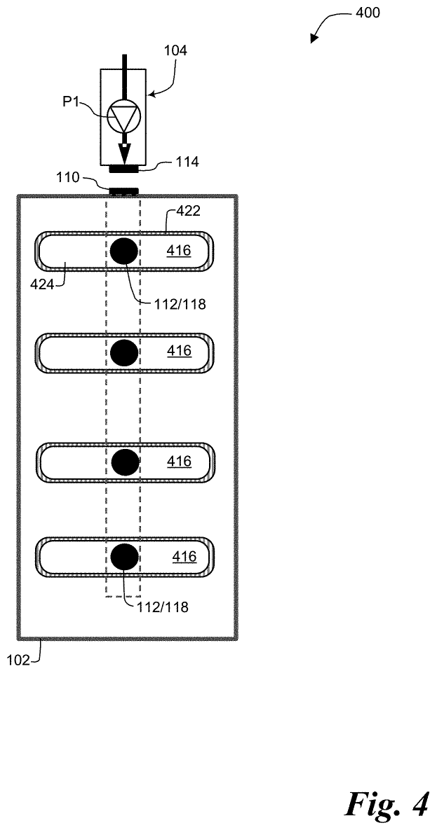

One or more fluid injectors 116 are fluidly coupled to manifold 102. Each fluid injector is a hollow cylindrical tube having a first end 118, a second end 120, and a curved sidewall 122. In the illustrated embodiment each injector 116 is a right circular cylinder, but in other embodiments other types of cylinders, for example cylinders with non-circular cross-sectional shape, can be used (see, e.g., FIG. 4). Curved sidewall 122 forms a boundary of an interior volume or internal channel 124 of the fluid injector. The first end 118 of each fluid injector includes a fluid connector 126 that can engage with fluid connector 112 of a corresponding supply outlet 108, so that each fluid injector 116 can be fluidly coupled to supply manifold 102. In some embodiments, for instance, fluid connectors 112 and 126 can be quick connect/disconnect connectors or dripless blind-mating connectors. In the illustrated embodiment every supply outlet 108 is fluidly coupled to a corresponding injector 116, but in other embodiments not every supply outlet need be coupled to an injector. Unused supply outlets 108 can either be capped or they can be closed off by using fluid connectors 112 that automatically close if not engaged with a corresponding connector 126—quick-disconnect connectors, for instance.

FIGS. 1B-1C together illustrate further details of fluid injectors 116. Curved sidewall 122 forms a boundary of the interior channel 124 of the fluid injector, and both ends 118 and 120 of each fluid injector are open (i.e., fluid can flow in and out of interior channel 124 through both ends). Curved sidewall 122 is perforated, meaning that it includes a plurality of perforations 128 that enable fluid flow between the interior and exterior of each injector. In one embodiment, perforations 128 are uniformly distributed on curved sidewall 122; put differently, the perforations are uniformly distributed along the circumference (FIG. 1B) and length (FIG. 1C) of the sidewall. In other embodiments of fluid injectors 116, perforations 128 need not be uniformly distributed, either circumferentially or longitudinally. Perforations 128 can also be understood as injection ports, and in different embodiments the perforations can have different shapes such as multiple square, round, elliptical, elongated (e.g. slots), etc.

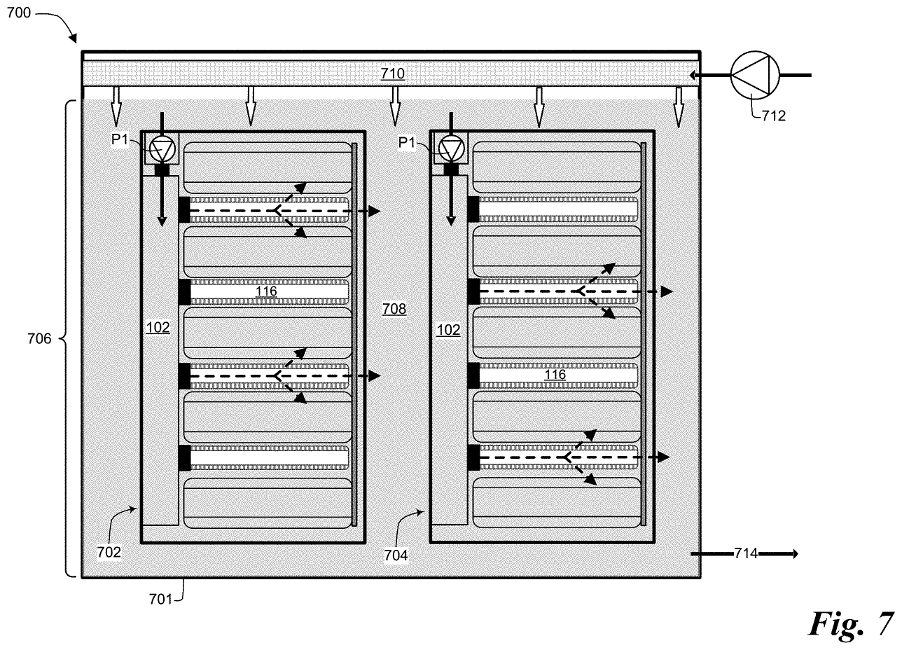

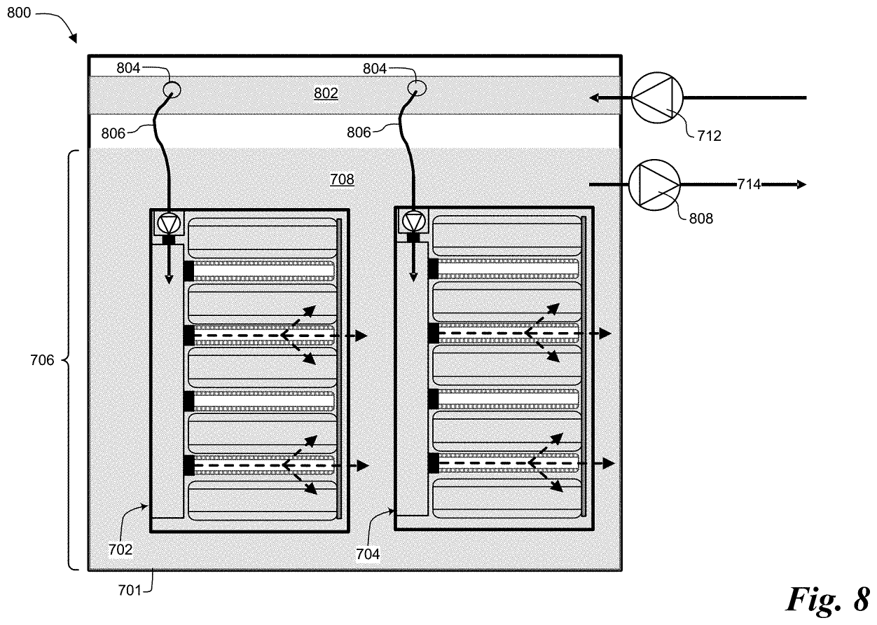

In operation of fluid injection system 100, one or more fluid injectors 116 are fluidly coupled to manifold 102. Manifold pump P1 pumps an immersion cooling fluid (see, e.g., FIGS. 7-8) into main inlet 106 and thus into supply manifold 102. Typical immersion cooling fluids used with fluid injection system 100 are dense and highly viscous, so manifold pump P1 can be necessary, in addition to a rack pump (see, e.g., FIG. 7-8) to drive the cooling fluid through the fluid injectors. The immersion cooling fluid then flows through manifold 102 and out of the manifold through each supply outlet 108 with an injector fluidly coupled to it. The immersion cooling fluid flows from manifold 102 into the interior channel 124 of each injector, then flows out of the interior channel through perforations 128 and second end 120. This fluid path in the injectors is illustrated by the dashed arrows in FIG. 1C.

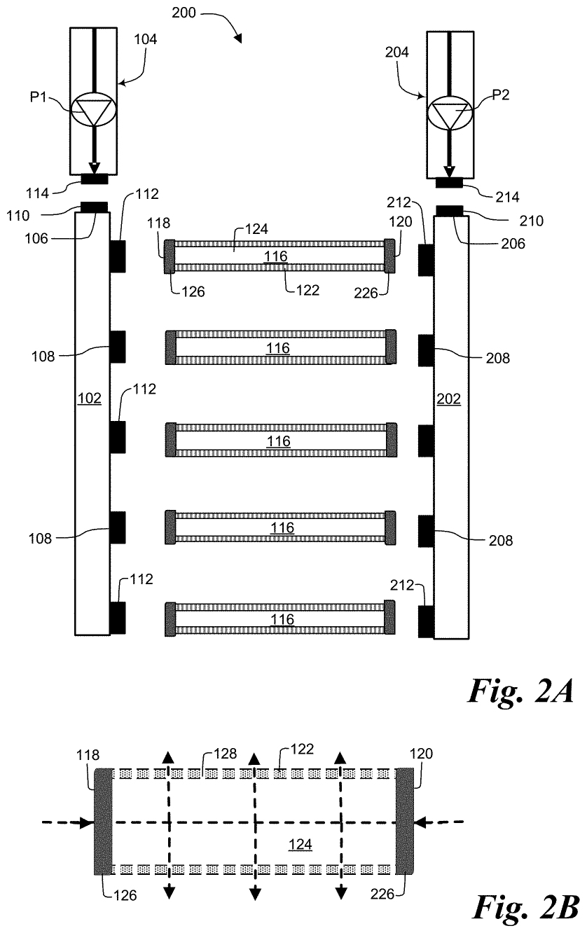

FIGS. 2A-2B together illustrate an embodiment of a fluid injection system 200. FIG. 2A is an exploded side view of the system and FIG. 2B is a cross-sectional side view of a fluid injector. Fluid injection system 200 is in most respects similar to fluid injection system 100. The primary difference between fluid injection systems 100 and 200 is that fluid injection system 200 includes two supply manifolds instead of one.

Fluid injection system 200 includes supply manifold 102 fluidly coupled to pump module 104 and to one or more fluid injectors 116 as described above. Fluid injection system 200 also includes a second or additional supply manifold 202 with a main inlet 206 and a plurality of supply outlets 208. Main inlet 206 includes a fluid connector 210, and each supply outlet 208 similarly includes a fluid connector 212. A pump module 204 has a manifold pump P2 and has a fluid connector 214 that can engage with fluid connector 210, so that pump module 204 and manifold pump P2 can be fluidly coupled to manifold 202. Typical immersion cooling fluids used with fluid injection system 100 are dense and highly viscous, so pumps P1 and P2 can be necessary, in addition to a rack pump (see, e.g., FIG. 7-8) to drive the cooling fluid through the fluid injectors.

Fluid injectors 116 are fluidly coupled to both supply manifolds 102 and 202. To accommodate this additional fluid coupling to supply manifold 202, the second end 120 of each fluid injector 116 includes a fluid connector 226 that can engage with a fluid connector 212 of a corresponding supply outlet 208. In some embodiments, fluid connectors 212 and 226 can be quick connect/disconnect connectors or dripless blind-mating connectors. In the illustrated embodiment every supply outlet 208 is fluidly coupled to a corresponding injector 116, but in other embodiments not every supply outlet need be coupled to an injector. As in system 100, in system 200 unused supply outlets 208 can either be capped or can be closed off by using fluid connectors 212 that automatically close if not engaged with a corresponding connector 226—quick-disconnect connectors, for instance.

FIG. 2B illustrates details of fluid injectors 116 in system 200. Fluid injectors 116 in system 200 have substantially the same construction as they do in system 100, except for the additional of fluid connector 226 on second end 120 that fluidly couples each fluid injector to additional supply manifold 202. Because its fluid injectors are coupled to two manifolds instead of one, system 200 operates slightly differently. In operation of fluid injection system 200, pumps P1 and P2 pump an immersion cooling fluid into supply manifolds 102 and 202. The immersion cooling fluid then flows through manifolds 102 and 202 and out through each of supply outlets 108 and 208 that are coupled to a fluid injector. The immersion cooling fluid thus flows through first end 118 and second end 120 into the interior channel 124 of each injector, then flows out of the interior channel through perforations 128. This fluid path in the injectors is illustrated by the dashed arrows in FIG. 2B.

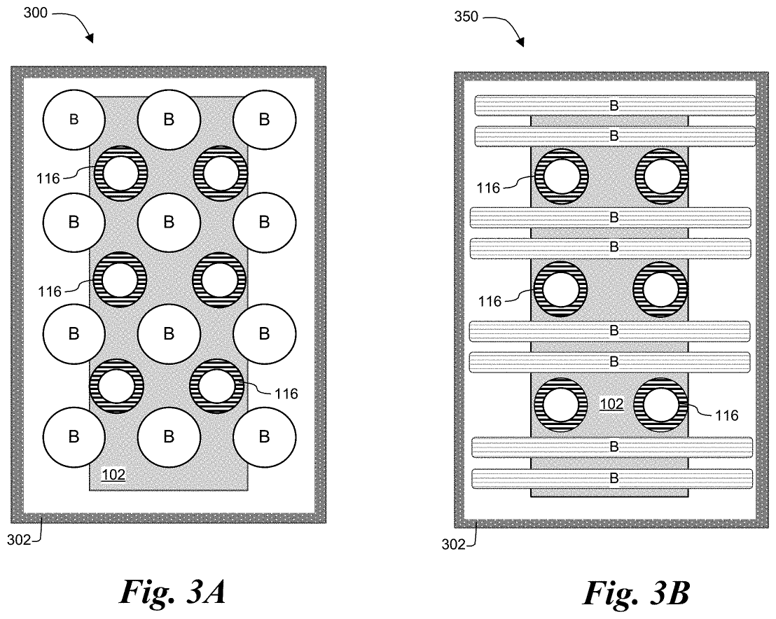

FIGS. 3A-3B illustrate embodiments of battery backup units (BBUs) with a fluid injection system such as system 100 or 200. FIGS. 3A-3B illustrate BBUs 300 and 350, respectively, each of which includes a perforated housing 302. Perforated housing 302 allows an immersion cooling fluid to flow through the housing in either direction—from interior to exterior or from exterior to interior. A plurality of spaced-apart battery cells B is positioned within housing 302, a fluid injection system such as system 100 or 200 is coupled to the housing and the battery cells inside. In the illustrated embodiment, battery cells B have a shape that is elongated and somewhat cylindrical, but in other embodiments they can have a different shape than shown.

The primary difference between BBUs 300 and 350 is how the injectors are oriented relative to the battery cells B. In both BBUs 300 and 350, fluid injectors are coupled to supply manifold 102 (and supply manifold 202 if present) and are disposed among and between the battery cells B. But in BBU 300 fluid injectors 116 are oriented substantially parallel to the battery cells B, whereas in BBU 350 fluid injectors 116 are oriented substantially perpendicular to the battery cells. Generally, each injector corresponds to a group of one or more batteries. In BBU 300, fluid injectors 116 are inserted between every row and column of battery cells, such that each fluid injector 116 forms a quincunx with four adjacent batteries. In BBU 350, fluid injectors 116 are inserted between groups of two rows of battery cells. Other arrangements of fluid injectors relative to the battery cells are of course possible in other embodiments of BBUs 300 and 350. In BBU 350, for instance, injectors 116 could be positioned within groups including a single row of battery cells B (similar to BBU 300, but with the injectors perpendicular to the battery cells) or could be positioned between groups of more than two rows of battery cells B. This arrangement of the battery cells and injections ports helps to ensure that cooling fluid can be injected and distributed to cover the surfaces of all the battery cells.

FIG. 4 illustrates another embodiment of a fluid injection system 400. Fluid injection system 400 is in most respects similar to fluid injection systems 100 and 200. The primary difference between fluid injection systems 100-200 and fluid injection system 400 is that the fluid injectors in fluid injection system 400 have a different cross-sectional shape.

Fluid injection system 400 includes supply manifold 102 fluidly coupled to one or more fluid injectors 416 by connectors 112 and 118, as described above for systems 100 and 200. Pump module 104 with manifold pump P1 is fluidly coupled to the main inlet of supply manifold 102 by fluid connectors 110 and 114, as also described above. The illustrated embodiment includes a single supply manifold 102, but other embodiments fluid injection system 400 can include two supply manifolds 102 and 202, and their associated fluid connections.

Fluid injectors 416 are in most respects similar to fluid injectors 116. Each injector 416 includes a sidewall 422 that forms an interior volume or interior channel 424 of the fluid injector, and both ends of each fluid injector are open (i.e., fluid can flow in and out of both ends of interior channel 424 through connectors that couple the injector to manifolds).

Sidewalls 422 are perforated, meaning that they include a plurality of perforations (not shown in this figure, but see FIGS. 1B-1C and 2B) that enable fluid flow between interior channel 424 and the exterior of each injector. In one embodiment, perforations are uniformly distributed on sidewall 422, but in other embodiments the perforations need not be uniformly distributed. The primary difference between fluid injectors 416 and fluid injectors 116 is the cross-sectional shape: fluid injectors 116 have a circular cross-sectional shape, while fluid injectors 416 have a non-circular cross-sectional shape. In the illustrated embodiment, fluid injectors 416 have a flattened quadrilateral cross-sectional shape, which can allow fluid injectors 416 to distribute cooling fluid to more area and more surrounding battery cells, but of course other embodiments can have other cross-sectional shapes.

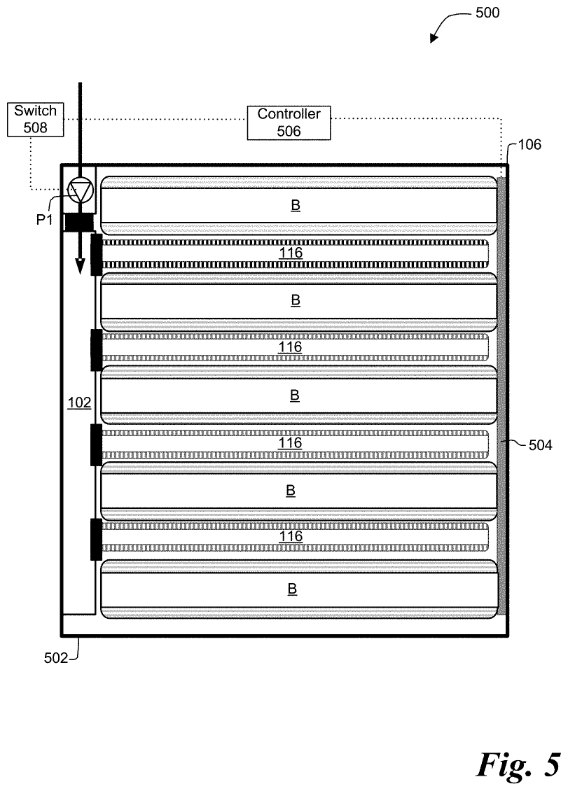

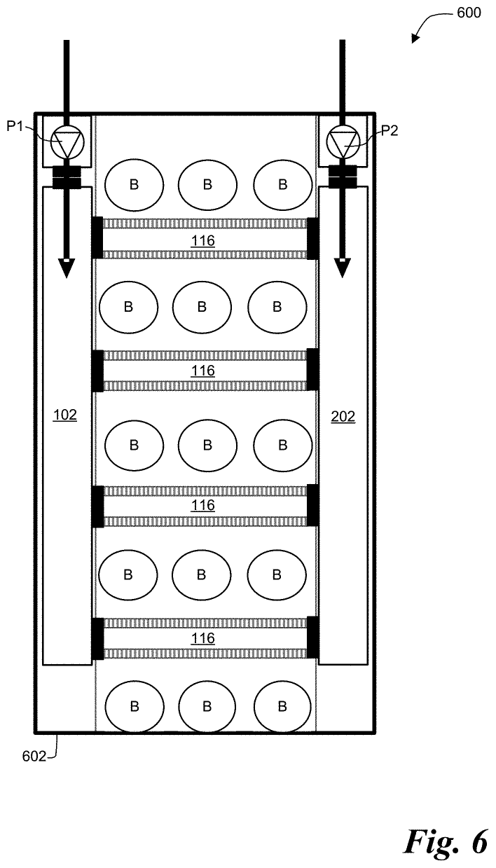

FIG. 5 illustrates an embodiment of a battery backup unit (BBU) 500 with a fluid injection system. In the illustrated embodiment BBU 500 uses single-manifold fluid injection system 100, but other embodiments can use dual-manifold fluid injection system 200 instead (see, e.g., FIG. 6). BBU 500 is similar to BBU 300: it includes a perforated housing 502, and a plurality of battery cells B are positioned within the perforated housing. A fluid injection system 100 is also positioned inside perforated housing 502, with fluid injectors 116 positioned relative to batteries B as shown in FIG. 3A—that is, with fluid injectors 116 substantially parallel to battery cells B. Fluid injectors 116 are fluidly coupled to supply manifold 102, and fluid supply manifold 102 is fluidly coupled to pump module 104 and manifold pump P1, as discussed above for fluid injection system 100.

BBU 500 also includes one or more electrical buses 504 that are electrically coupled to one or more battery cells B. When batteries B are discharging, electrical buses 504 can be used to provide electricity from the batteries to other electrical components; when batteries B are charging, electrical buses 504 can be used to provide electricity to the batteries. Batteries B require cooling only when charging or discharging. In the illustrated embodiment the one or more electrical buses 504 can be electrically coupled to a charging/discharging controller 506, which is in turn electrically coupled to a switch 508 and to manifold pump P1. With this arrangement, controller 506 can sense when the batteries are charging and discharging and only activate manifold pump P1 when cooling is required. When battery cells B are discharging controller 508 and switch 508 can also direct electricity from electrical bus 504 to manifold pump P1, so that the pump is at least partially operated with electricity from the battery cells. This arrangement also provides some automatic control of manifold pump P1, so that the pump automatically delivers more cooling fluid into and through housing 502 and battery cells B when more cooling is needed. When batteries B are discharging at their highest rate, and thus generating the most heat, more electricity is sent to manifold pump P1, so that the pump directs more immersion cooling fluid into fluid injectors 116 and through batteries B. As the discharge rate decreases less electricity and heat are generated, so that manifold pump P1 pumps less cooling fluid into and through fluid injectors 116.

FIG. 6 illustrates an embodiment of a battery backup unit (BBU) 600 with a fluid injection system. BBU 600 is in most respects similar to BBU 500. The primary differences between BBUs 500 and 600 are that BBU 600 uses dual-manifold fluid injection system 200 instead of single-manifold fluid injection system 100, and that in BBU 600 fluid injectors 116 are positioned differently than in BBU 500. BBU 600 includes a perforated housing 602, and a plurality of battery cells B are positioned within perforated housing 602. Fluid injection system 200 is also positioned inside perforated housing 602, with supply manifold 102 and 202 positioned within housing 602 and fluid injectors 116 positioned relative to batteries B as shown in FIG. 3B—that is, with fluid injectors 116 substantially perpendicular to battery cells B. Fluid injectors 116 have their ends fluidly coupled to both supply manifolds 102 and 202. Fluid supply manifold 102 is fluidly coupled to pump module 104 and manifold pump P1, and fluid supply manifold 202 is fluidly coupled to pump module 204 and manifold pump P2, as discussed above for fluid injection system 200. Both pumps P1 and P2 are fluidly coupled to a source of immersion cooling fluid (see, e.g., FIGS. 7-8). By using two manifolds, BBU 600 provides redundant double distribution of cooling fluid. Although not shown in the figure, BBU 600 can also include an electrical bus 504, controller 506, and switched 508 as discussed above for BBU 500.

FIG. 7 illustrates an embodiment of an IT enclosure 700 including a battery backup unit with a fluid delivery system. In the illustrated embodiment IT enclosure 700 includes two BBUs 702-704, both configured as described above for BBU 500, but other embodiments of IT enclosure 700 can have a different number of BBUs than shown and the individual BBUs can be also configured differently than shown, for instance by configuring them like BBU 600. In still other embodiments not all BBUs in the IT enclosure need be configured the same way. For instance, some can use single-manifold fluid injection system 100 while others use dual-manifold fluid injection system 200.

IT enclosure 700 includes an IT rack 701, the lower part of which forms a reservoir 706 filled with an immersion cooling fluid 708. Reservoir 706 can be also understood as the regions within enclosure 700 that are filled with cooling fluid, so that there need not be an actual reservoir that is a separate element of the enclosure. Reservoir 706 includes a rack outlet 714 that can be used to drain immersion cooling fluid 708 from the reservoir. BBUs 702 and 704 are fully submerged in immersion cooling fluid 708, and both are submerged far enough in the immersion cooling fluid that the main inlets of their pump modules are below the surface of cooling fluid 708. As described above for BBUs 500 and 600, the housing of each BBU 702-704 is perforated so that when the BBU is immersed in immersion cooling fluid 708, the BBU also fills up with immersion cooling fluid 708. Also positioned within the rack 701 is a fluid distributor 710 that is coupled by a rack supply pump 712 to a source of immersion cooling fluid. Fluid distributor 710 distributes immersion cooling fluid received from the cooling fluid source into reservoir 706.

In operation of IT enclosure 700, fluid distributor 710 receives immersion cooling fluid from rack supply pump 712 and distributes it into reservoir 706. To maintain a certain level of immersion cooling fluid 708 in reservoir 706, cooling fluid exits the reservoir through outlet 714 in an amount that substantially balances the amount entering through fluid distributor 710 minus any fluid losses due to leaks or evaporation. When battery cells B within one both of BBU's 702 and 704 are charging or discharging, thus requiring cooling, pumps P1 and/or P2 are activated, taking fluid 708 from reservoir 706 into manifolds 102 and fluid injectors 116. Fluid flowing into and through fluid injectors 116 then flows out of the fluid injectors through the porous sidewall and through the second end of each injector, as illustrated by the dashed arrows in the figure. As it exits the fluid injectors, immersion cooling fluid 708 flows over the battery cells B, cooling them. After flowing over the battery cells B, immersion cooling fluid 708 flows into the BBU housing and then, through the perforations in each BBU's housing, back into reservoir 706.

FIG. 8 illustrates an embodiment of an IT enclosure 800 including a battery backup unit with a fluid delivery system. IT enclosure 800 is in most respects similar to IT enclosure 700: it includes two BBUs 702-704, both of which are configured as described above for BBU 500, but other embodiments of IT enclosure 700 can have a different number of BBUs than show. In other embodiments the BBUs can be also configured differently than shown, for instance by configuring them like BBU 600, and in still other embodiments not all BBUs in the IT enclosure need be configured the same way. IT enclosure 800 includes an IT rack 701, the lower part of which forms a reservoir 706 filled with an immersion cooling fluid 708. As in IT enclosure 700, reservoir 706 can be also understood as the regions within enclosure 700 that are filled with coolant, so that there need not be an actual reservoir that is a separate element of the enclosure. Reservoir 706 includes an outlet 714 that can be used to drain immersion cooling fluid 708 from the reservoir. BBUs 702 and 704 are fully submerged in immersion cooling fluid 708, and both are submerged far enough in the immersion cooling fluid that the main inlets of their fluid supply manifolds are below the surface of cooling fluid 708. As described above for BBUs 500 and 600, the housing of each BBU is perforated so that when each BBU is immersed in immersion cooling fluid 708 it fills up with immersion cooling fluid 708.

The primary difference between IT enclosures 700 and 800 is that IT enclosure 800 distributes fluid to BBUs 702-704 differently. In IT enclosure 800 a fluid distributor 802 is coupled by rack supply pump 712 to a source of immersion cooling fluid. Fluid distributor 802 includes outlet ports 804, and fluid lines 806 are used to couple outlet ports 804 to manifold pump P1 in BBU 702 and manifold pump P2 in BBU 704. With this type of fluid coupling, fluid distributor 802 distributes immersion cooling fluid directly into each BBU's fluid injection system instead of simply delivering it into reservoir 706 as it does in IT enclosure 700. An additional difference is that IT enclosure 800 includes a rack outlet pump 808 coupled to outlet 714. Rack outlet pump 808, together with rack supply pump 712, form a closed loop for controlling and maintaining the level of immersion cooling fluid in reservoir 706 and better managing the fluid for different operation scenarios.

In operation of IT enclosure 800, fluid distributor 802 receives immersion cooling fluid from rack supply pump 712 and distributes it directly into the supply manifolds 102 within BBUs 702 and 704. To maintain a certain level of immersion cooling fluid 708 in reservoir 706, or maintain the designed level of fluid 708 in reservoir 706, cooling fluid exits the reservoir through rack outlet pump 808 and outlet 714 in an amount that substantially balances the amount entering through fluid distributor 710 minus any fluid losses due to leaks or evaporation. When battery cells B within one both of BBU's 702 and 704 are charging or discharging, thus requiring cooling, pumps P1 and/or P2 are activated, taking fluid 708 from fluid distributor 802 into manifolds 102 and fluid injectors 116. Fluid flowing into and through fluid injectors 116 then flows out of the fluid injectors through the porous sidewall and through the second end of each injector, as illustrated by the dashed arrows in the figure. As it exits the fluid injectors, immersion cooling fluid 708 flows over the battery cells B, cooling them. After flowing over the battery cells B, immersion cooling fluid 708 flows into the BBU housing and then, through the perforations in each individual BBU's housing, back into reservoir 706.

Other embodiments are possible besides the ones described above. For instance:
The fluid injectors can be optimized for different battery cell arrangements.
The supply manifolds can be integrated to the battery pack.
The cooling module can be designed in different optimized manners to accommodate the battery pack.

The above description of embodiments is not intended to be exhaustive or to limit the invention to the described forms. Specific embodiments of, and examples for, the invention are described herein for illustrative purposes, but various modifications are possible.

What is claimed is:

1. A fluid injection apparatus comprising:
a supply manifold including a main inlet and a plurality of supply outlets; and
one or more fluid injectors adapted to be inserted among battery cells in a battery backup unit, wherein:
each fluid injector comprises a tube having a first end, a second end, and a sidewall extending between the first end and the second end,
the sidewall of each fluid injector includes a plurality of perforations, so that fluid can flow through the plurality of perforations from an interior channel of the fluid injector to an exterior of the fluid injector, and
the first end of each fluid injector is fluidly coupled to a corresponding supply outlet.

2. The fluid injection apparatus of claim 1 wherein each fluid injector is fluidly coupled by fluid connectors to the supply manifold.

3. The fluid injection apparatus of claim 1 wherein the second end of each fluid injector is open, so that fluid can flow through the second end from the interior channel of the fluid injector to the exterior of the fluid injector.

4. The fluid injection apparatus of claim 1, further comprising an additional supply manifold including a main inlet and a plurality of supply outlets, wherein each fluid injector has its second end coupled to a corresponding supply outlet of the additional supply manifold so that fluid flows from the additional supply manifold into the interior channel of the fluid injector.

5. The fluid injection apparatus of claim 4, further comprising an additional manifold pump fluidly coupled to the main inlet of the additional supply manifold.

6. The fluid injection apparatus of claim 1 wherein the perforations are uniformly distributed over an area of the sidewall.

7. The fluid injection apparatus of claim 1 wherein the one or more fluid injectors have a noncircular cross-sectional shape.

8. A battery backup unit comprising:
a battery housing having a plurality of perforations therein;
a plurality of battery cells positioned in the battery housing;
a fluid injection system coupled to the housing, the fluid injection system comprising:
a supply manifold including a main inlet and a plurality of supply outlets; and
one or more fluid injectors inserted among the plurality of battery cells, wherein:
each fluid injector comprises a tube having a first end, a second end, and a sidewall extending between the first end and the second end,
the sidewall of each fluid injector includes a plurality of perforations, so that fluid can flow through the plurality of perforations from an interior channel of the fluid injector to an exterior of the fluid injector, and
the first end of each fluid injector is fluidly coupled to a corresponding supply outlet.

9. The battery backup unit of claim 8 wherein the fluid injectors are positioned between groups of battery cells, each group including at least one battery cell.

10. The battery backup unit of claim 8 wherein the fluid injectors are oriented parallel to the plurality of battery cells.

11. The battery backup unit of claim 8 wherein the fluid injectors are oriented perpendicular to the plurality of battery cells.

12. The battery backup unit of claim 8, further comprising an electrical bus electrically coupled to the plurality of battery cells.

13. The battery backup unit of claim 12, further comprising:
a charging/discharging controller electrically coupled to the electrical bus; and
a switch electrically coupled to the controller and to a manifold pump fluidly coupled to the main inlet of the fluid injection system;
wherein the charging/discharging controller activates the switch to direct power to the manifold pump when the plurality of battery cells is charging or discharging, and wherein, when the plurality of battery cells is charging, the manifold pump can be operated by power from the electrical bus.

14. The battery backup unit of claim 8, further comprising an additional supply manifold including a main inlet and a plurality of supply outlets, wherein each fluid injector has its second end coupled to a supply outlet of the additional supply manifold so that fluid flows from the additional supply manifold into the interior channel of the fluid injector.

15. An information technology (IT) enclosure comprising:
an IT rack having a lower portion that forms a reservoir adapted to be filled with an immersion cooling fluid;
one or more battery backup units positioned in the IT rack, each battery backup unit being submerged in the immersion cooling fluid and each battery backup unit comprising:
a battery housing having therein a plurality of perforations;
a plurality of battery cells positioned in the battery housing; and
a fluid injection system coupled to the housing, the fluid injection system comprising:
a supply manifold including a main inlet and a plurality of supply outlets; and
one or more fluid injectors inserted among the plurality of battery cells, wherein:
each fluid injector comprises a tube having a first end, a second end,
and a sidewall extending between the first end and the second end,
the sidewall of each fluid injector includes a plurality of perforations, so that fluid can flow through the plurality of perforations from an interior channel of the fluid injector to an exterior of the fluid injector, and
the first end of each fluid injector is fluidly coupled to a corresponding supply outlet.

16. The IT enclosure of claim 15, further comprising:
a fluid distributor positioned in the IT rack, the fluid distributor being fluidly coupled to a manifold pump fluidly coupled to the main inlet of the fluid injection system of each battery backup unit; and
a rack supply pump fluidly coupled to the fluid distributor to pump immersion cooling fluid into the fluid distributor.

17. The IT enclosure of claim 15, further comprising:
a fluid distributor positioned in the IT rack, the fluid distributor being adapted to deliver immersion cooling fluid into the reservoir; and
a rack supply pump fluidly coupled to the fluid distributor to pump immersion cooling fluid into the fluid distributor.

18. The IT enclosure of claim 15, further comprising a rack outlet fluidly coupled to the reservoir.

19. The IT enclosure of claim 18, further comprising a rack outlet pump fluidly coupled to the rack outlet to pump immersion cooling fluid out of the reservoir.

20. The IT enclosure of claim 15 further comprising an additional supply manifold including a main inlet and a plurality of supply outlets, wherein each fluid injector has its second end coupled to a corresponding supply outlet of the additional supply manifold so that fluid flows from the additional supply manifold into the interior channel of the fluid injector.
